(19) United States
(12) Patent Application Publication
(10) Pub. No.: US 2017/0134355 A1
(43) Pub. Date: May 11, 2017

(54) VEHICLE-BASED NETWORK DATA TRANSMISSION METHOD AND DEVICE

(71) Applicant: Leauto Intelligent Technology (BEIJING) Co. Ltd., Beijing (CN)

(72) Inventors: Yong XU, Beijing (CN); Yu ZOU, Beijing (CN); Kunsheng CHEN, Beijing (CN); Wenrui LI, Beijing (CN); Dan LI, Beijing (CN); Peng LIU, Beijing (CN); Wei LIN, Beijing (CN)

(21) Appl. No.: 14/970,220

(22) Filed: Dec. 15, 2015

(30) Foreign Application Priority Data
Nov. 10, 2015 (CN) 201510762590.6

(51) Int. Cl. H04L 29/06; H04L 29/08

(52) U.S. Cl. CPC H04L 63/08; H04L 67/12

(57) ABSTRACT

The present disclosure provides a vehicle-based network data transmission method and device. The method includes: receiving, by a server, a request from a current vehicle for acquiring network data; obtaining information of a virtualized base station group according to the request; and transmitting, by the server, the network data to the current vehicle through the virtualized base station group.

### CROSS-REFERENCE TO RELATED APPLICATION

This application claims the benefit and priority of Chinese Patent Application No. 201510762590.6 filed Nov. 10, 2015. The entire disclosure of the above application is incorporated herein by reference.

### FIELD

The present disclosure relates to the technical field of communication, in particular to a vehicle-based network data transmission method and a vehicle-based network data transmission device.

### BACKGROUND

With the gradual development of intelligent transportation, automatic driving and cooperative vehicle-infrastructure techniques, as vehicle becomes a new scenario of application of the Internet and Internet of Things, a great number of applications have been created, such as listening to music, watching videos, watching live videos and playing online games in vehicles. These applications produce great demand for data communication.

In the existing Vehicle-to-X (V2X) communications system, communication channels are divided into data channels and control channels. The control channels are mainly used for transmitting data related to vehicle running safety, and the data channels are mainly used for transmitting data related to applications, including video stream data. For multimedia applications, a video stream is one of applications which consume the most bandwidth.

In the current V2X communication environment, if application programs need to be used, vehicles need to firstly perform identity authentication, network correlation and data security service with base stations, and thereafter transmission of network data can be performed. However, wireless communication in automobiles is different from the traditional wifi and 3G/4G communication and has the most important characteristic of mobility. Under high-speed movement environments, vehicle speed can reach 50 m/s. However, an average coverage radius of a base station is 300m. At the boundary between the coverages of two base stations, handover between the two base stations is required, and identity authentication, network correlation and data security service need to be performed again with the target base station, and the whole process can cost up to 2 seconds. If users are watching videos or live television at this time, the video may stutter. To solve this problem, the traditional solution is to use a video buffer pool, i.e., some video data are stored in advance in areas with good V2X signal coverage performance, and thereby smooth play can be realized when playing video in areas where handover between base stations is performed. However, the biggest disadvantage of the buffer pool is that the real-time performance is poor, the vehicles cannot receive the video stream data in real time, and long-time delay will occur when users are watching live television programs.

### SUMMARY

One embodiment of the present disclosure provides a vehicle-based network data transmission method, which includes the following:

a server receiving a request from a current vehicle for acquiring network data;

obtaining information of a virtualized base station group according to the request; and

the server transmitting the network data to the current vehicle through the virtualized base station group.

One embodiment of the present disclosure further provides a vehicle-based network data transmission device, which includes:

one or more processor; and

a memory; wherein:

one or more computer readable program codes are stored in the memory, and the one or more processors are configured to perform the one or more computer readable program codes to perform:

receiving a request from a current vehicle for acquiring network data;

obtaining information of a virtualized base station group according to the request; and

transmitting the network data to the current vehicle through the virtualized base station group.

### BRIEF DESCRIPTION OF THE DRAWINGS

In order to more clearly describe the embodiments of the present disclosure or the technical solution in the prior art, the drawings which need to be used in the description of the embodiments or the prior art will be simply introduced below. Obviously, the drawings described below just show some embodiments of the present disclosure. Those skilled in the art can obtain other drawings according to these drawings without any inventive effort.

FIG. 1 illustrates a flowchart of a vehicle-based network data transmission method according to an embodiment of the present disclosure;

FIG. 2 illustrates a flowchart of a vehicle-based network data transmission method according to an embodiment of the present disclosure;

FIG. 3 illustrates a flowchart of a vehicle-based network data transmission method according to an embodiment of the present disclosure;

FIG. 4 illustrates a structural schematic diagram of a vehicle-based network data transmission device according to an embodiment of the present disclosure.

FIG. 5 illustrates a structural schematic diagram of a vehicle-based network data transmission device according to an embodiment of the present disclosure.

### DETAILED DESCRIPTION

In order to make the objects, technical solutions, and advantages of the present disclosure more apparent, the present disclosure will be described below in further details with reference to the drawings and particular embodiments thereof. Although the exemplary embodiments of the present disclosure are illustrated in the drawings, it shall be appreciated that the present disclosure can be embodied in various forms but will not be limited to the embodiments described here. On the contrary, these embodiments are provided in order to enable thorough understanding of the present disclosure and to enable the full scope of the present disclosure to be conveyed to those skilled in the art.

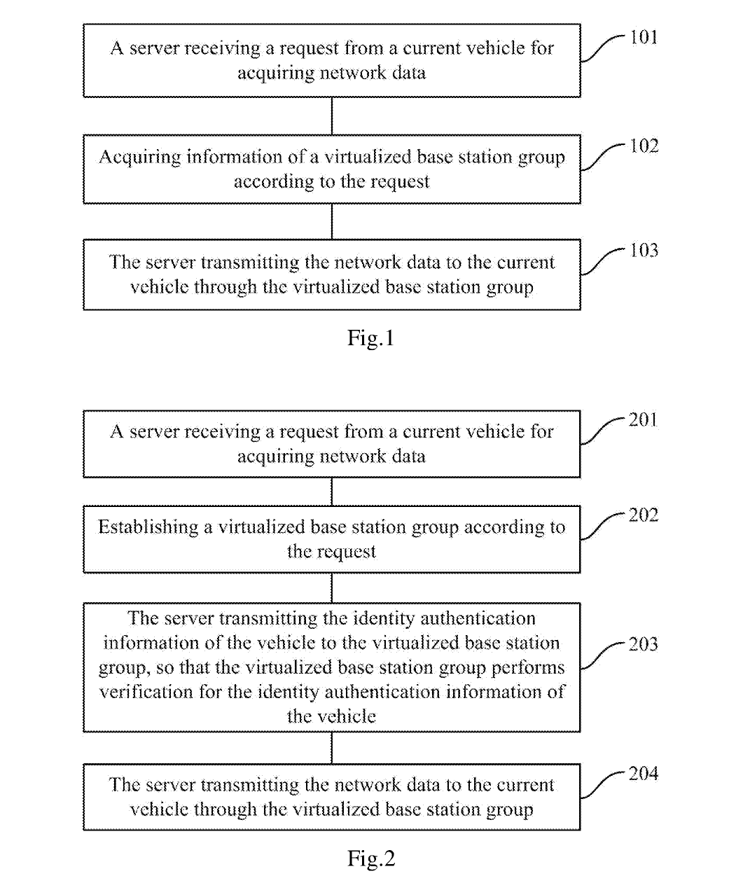

Referring to FIG. 1, which illustrates a flowchart of a vehicle-based network data transmission method according to the first embodiment of the present disclosure, the method includes the following operations:

Operation 101: a server receiving a request from a current vehicle for acquiring network data;

When an application program is used in a running vehicle, firstly communication connection with a base station and the server is needed to establish, and then the server can transmit the network data such as video stream data to the vehicle through the base station. Therefore, in the embodiment of the present disclosure, the server can receive the request from the current vehicle for acquiring the network data, where the request can include identity authentication information of the current vehicle.

Operation 102: obtaining information of a virtualized base station group according to the request;

In this embodiment of the present disclosure, the information of virtualized base station group can be obtained according to the request from the current vehicle for acquiring the network data, and the virtualized base station group consists of one or more of target base stations by which the current vehicle passes or will pass.

In a preferred embodiment of the present disclosure, the operation of obtaining the information of virtualized base station group according to the request further includes the following sub-operations:

Sub-operation S11: determining whether an virtualized base station group exits according to the request;

Sub-operation S12: if so, directly obtaining the information of the virtualized base station group;

Sub-operation S13: if not, establishing a virtualized base station group.

When different application programs are used during running of the vehicle, the vehicle needs to request for acquiring the network data for the application programs. If the virtualized base station group has already been established before, the information of the virtualized base station group can be directly obtained for use.

Therefore, in a preferred embodiment of the present disclosure, whether an virtualized base station group exits can be determined in advance; if so, the information of the virtualized base station group can be directly obtained; and if not, a virtualized base station group can be established.

Sub-operation 103: the server transmitting the network data to the current vehicle through the virtualized base station group.

After the information of the virtualized base station group is obtained, the server can transmit the network data to the current vehicle through each target base station in the virtualized base station group.

In the embodiment of the present disclosure, by obtaining the information of the virtualized base station group and then transmitting the network data to the current vehicle through each target base station in the virtualized base station group, the time for the handover between the base stations during running of the vehicle is reduced, the handover between the base station can be quickly completed, the transmission of the network data can not be interrupted thereby and the real-time transmission of the network data is realized.

Referring to FIG. 2, which illustrates a flowchart of a vehicle-based network data transmission method according to a second embodiment of the present disclosure, the method includes the following operations:

Operation 201: a server receiving a request from a current vehicle for acquiring network data;

When an application program is used during running of the vehicle, firstly communication connection with a base station and the server is needed to establish, and then the server can transmit the network data such as video stream data to the vehicle through the base station. Therefore, in the embodiment of the present disclosure, the server can receive the request from the current vehicle for acquiring the network data, where the request can include identity authentication information of the current vehicle.

Operation 202: establishing a virtualized base station group according to the request;

In this embodiment of the present disclosure, the virtualized base station group can be established according to the request from the current vehicle for acquiring the network data, and the virtualized base station group consists of one or more of target base stations by which the current vehicle passes or will pass.

In implementation, navigation route information of the vehicle can be obtained according to the request, one or more of target base stations by which the vehicle passes or will pass can be determined according to the navigation route information and the one or more of target base stations can be organized to form the virtualized base station group.

Operation 203: the server transmitting the identity authentication information of the vehicle to the virtualized base station group, and the virtualized base station group performs verification for the identity authentication information of the vehicle;

After the virtualized base station group is established, identity authentication, network correlation and data security service can be performed between the current vehicle and the virtualized base station group. In one embodiment, the server can transmit the identity authentication information of the vehicle to the virtualized base station group, and then the virtualized base station group can perform verification for the identity authentication information of the vehicle, network correlation, data security service and the like can also be performed.

If the verification passes, Operation 204 is executed.

If the verification performed by the virtualized base station group for the identity authentication information of the current vehicle passes, it indicates that the current vehicle has already completed the registration in the virtualized base station group, then operation 204, in which the server transmits the network data to the current vehicle through the virtualized base station group can be executed.

If the verification fails, verification fail information is returned to the server.

If the verification performed by the virtualized base station group for the identity authentication information of the current vehicle fails, in one embodiment of the present disclosure, verification fail information can be returned to the server and the server can transmit the identity authentication information of the current vehicle to the virtualized base station group for verification again.

Operation 204: the server transmitting the network data to the current vehicle through the virtualized base station group.

If the verification performed by the virtualized base station group for the identity authentication information of the current vehicle passes, virtualized base station group can transmit the network data to the current vehicle.

In the embodiment of the present disclosure, by establishing the virtualized base station group and transmitting, by the server, the identity authentication information of the current vehicle to the virtualized base station group for verification, a process needed for verifying the identity authentication information of the vehicle each time when the base station is switched during running is avoided, verification for identity authentication information does not need to be performed again with the target base station, thereby the target base station can directly transmit the network data to the vehicle, the transmission of the network data can be prevented from being interrupted due to the handover between the base stations and the real-time transmission of the network data can be realized.

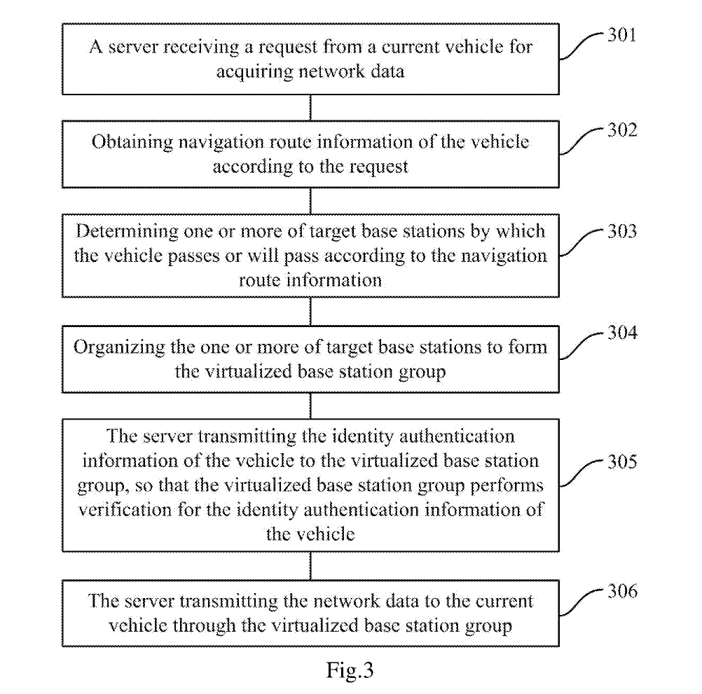

Referring to FIG. 3, which illustrates a flowchart of a vehicle-based network data transmission method according to a third embodiment of the present disclosure, the method includes the following operations:

Operation 301: a server receiving a request from a current vehicle for acquiring network data;

When an application program is used during running of the vehicle, firstly communication connection with a base station and the server is needed to establish, and then the server can transmit the network data such as video stream data to the vehicle through the base station. Therefore, in the embodiment of the present disclosure, the server can receive the request from the current vehicle for acquiring the network data.

Operation 302: obtaining navigation route information of the vehicle according to the request;

In the embodiment of the present disclosure, in a process that the current vehicle transmits the request for acquiring the network data to the server, the request can further include the identity authentication information of the current vehicle and information such as current position, running direction and destination position of the vehicle, such that the server can obtain the navigation route information of the vehicle.

Operation 303: determining one or more of target base stations by which the vehicle passes or will pass according to the navigation route information;

The server can further determine one or more of target base stations by which the vehicle passes or will pass according to the navigation route information. Target base stations are base stations by which the vehicle passes or will pass during running. For example, if there are a base station A, a base station B, a base station C, a base station D and a base station E, the position of the current vehicle is under the coverage of the base station A and the network data needed by the current vehicle for using an application program is transmitted through the base station A; then the vehicle will leave the base station A and will be under the coverage of the base station C with the vehicle in motion, the network data needed for using the application program will be transmitted to the current vehicle through the base station C after the handover between the base stations at this moment; and when the vehicle continuously runs, the vehicle will further pass by the base station D and thereby the base station A, the base station C and the base station D can be determined as the target base stations, wherein the base station at the current position of the vehicle is a current target base station.

Operation 304: organizing the one or more of target base stations to form the virtualized base station group;

After the server determines the one or more of target base stations, the one or more of target base stations can be organized to form the virtualized base station group.

Operation 305: the server transmitting the identity authentication information of the vehicle to the virtualized base station group, wherein the virtualized base station group performs verification for the identity authentication information of the vehicle; if the verification passes, proceeding with operation 306;

In implementation, the server can transmit the identity authentication information of the vehicle to the target base stations in the virtualized base station group, and verification is performed for the identity authentication information of the vehicle and network correlation and data security service are also performed through the target base stations. If the verification passes, the identity authentication information of the vehicle, network correlation information and data security service information are stored in each target base station in the virtualized base station group. At this moment, proceeding with operation 306.

In another embodiment of the present disclosure, the server can transmit the identity authentication information of the vehicle to the current target base in the virtualized base station group, and verification is performed for the identity authentication information of the vehicle and network correlation and data security service are performed through the current target base station. If the verification passes, the identity authentication information of the vehicle, the network correlation information, the data security service information and the like stored in the current target base station can be copied to other target base stations in the virtualized base station group. At this moment, proceeding with operation 306.

Operation 306: the server transmitting the network data to the current vehicle through the virtualized base station group.

In implementation, the server can transmit the network data to the current vehicle through each target base station in the virtualized base station group.

In the embodiment of the present disclosure, the operation of the server transmitting the network data to the current vehicle through the virtualized base station group can include the following sub-operations:

Sub-operation S31: the server respectively receiving verification pass authentication information transmitted by the target base stations;

Sub-operation S32: the target base station transmitting the network data to the current vehicle.

In the embodiment of the present disclosure, the server can respectively receive verification pass authentication information transmitted by the target base stations, and the respective target base stations transmit the network data to the current vehicle. Since information about identity authentication, network correlation, data security service of the vehicle and the like has already been stored in advance in each target base station in the virtualized base station group, when the vehicle become under the coverage range of another target base station after the handover between the base stations, identity authentication between the target base station and the vehicle do not need to be performed again and the network data can be directly transmitted to the vehicle.

In the embodiment of the present disclosure, by determining the one or more of target base stations by which the current vehicle passes or will pass, organizing the one or more of target base stations to form the virtualized base station group and performing verification for the identity authentication information of the vehicle in advance by each target base station in the virtualized base station group, verification does not need to be performed again with the target base station when handover between the base stations is performed during running of the vehicle, the time used for the handover between the base stations is reduced, thereby the transmission of the network data between the target base station and the vehicle is not interrupted due to the handover between the base stations and the real-time transmission of the network data is realized.

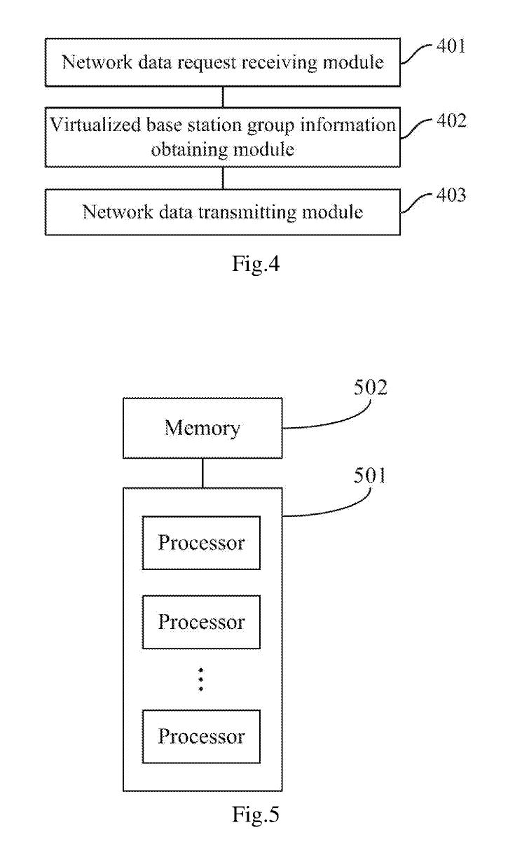

Referring to FIG. 4, which illustrates a structural schematic diagram of the embodiment of a vehicle-based network data transmission device according to the present disclosure, the device includes the following modules:

a network data request receiving module 401 configured to receive a request from a current vehicle for acquiring network data;

a virtualized base station group information obtaining module 402 configured to obtain information of a virtualized base station group according to the request; and

a network data transmitting module 403 configured to transmit the network data to the current vehicle through the virtualized base station group.

In the embodiment of the present disclosure, the virtualized base station group information obtaining module 402 can further include the following sub-module:

a virtualized base station group information determining and obtaining sub-module 41 configured to determine whether a virtualized base station group exists or not according to the request; if so, to obtain the information of the virtualized base station group directly; and if not, to establish a virtualized base station group.

In the embodiment of the present disclosure, the request further includes identity authentication information of the vehicle; and the device can further include the following module:

an identity authentication information verification module 404 configured to transmit the identity authentication information of the vehicle to the virtualized base station group, so that the virtualized base station group can perform verification for the identity authentication information of the vehicle; if the verification passes, then the server can transmit the network data to the vehicle through the virtualized base station group; and

if the verification fails, the identity authentication information verification module 404 is further configured to return verification fail information to the server.

In the embodiment of the present disclosure, the virtualized base station group information determining and obtaining sub-module 41 can further include the following units:

a navigation route information obtaining unit 411 configured to obtain navigation route information of the vehicle according to the request;

a target base station determining unit 412 configured to determine one or more of target base stations by which the vehicle passes or will pass according to the navigation route information; and

a virtualized base station group organization unit 413 configured to organize the one or more of target base stations to form the virtualized base station group.

In the embodiment of the present disclosure, the network data transmitting module 403 can include the following sub-modules:

an identity authentication information receiving sub-module 42 configured to respectively receive verification pass authentication information transmitted by the target base stations; and

a network data transmission sub-module 43 configured to transmit the network data to the vehicle.

The relevant functional modules illustrated in FIG. 4 can be embodied as a hardware processor in an embodiment of the disclosure. In a particular implementation, as illustrated in FIG. 5, there is a schematic diagram of a vehicle-based network data transmission device according to an embodiment of the present disclosure, which can include:

one or more processor 501; and

a memory 502; wherein:

one or more computer readable program codes are stored in the memory 502, and the one or more processors 501 are configured to perform the one or more computer readable program codes to perform:

receiving a request from a current vehicle for acquiring network data;

obtaining information of a virtualized base station group according to the request; and

transmitting the network data to the current vehicle through the virtualized base station group.

In one embodiment, wherein the obtaining the information of the virtualized base station group according to the request includes:

determining whether a virtualized base station group exists or not according to the request; if so, directly obtaining the information of the virtualized base station group; and if not, establishing a virtualized base station group.

In one embodiment, the request includes identity authentication information of the vehicle; and after obtaining the information of the virtualized base station group according to the request, the one or more computer readable program codes are further executed to perform:

transmitting the identity authentication information of the vehicle to the virtualized base station group, so that the virtualized base station group performs verification for the identity authentication information of the vehicle; if the verification passes, performing the operation of transmitting the network data to the vehicle through the virtualized base station group; and

if the verification fails, returning verification fail information to the server through the virtualized base station group.

In one embodiment, the establishing the virtualized base station group includes:

obtaining navigation route information of the vehicle according to the request;

determining one or more of target base stations by which the vehicle passes according to the navigation route information; and

organizing the one or more of target base stations to form the virtualized base station group.

In one embodiment, the transmitting the network data to the current vehicle through the virtualized base station group includes:

receiving verification pass authentication information transmitted by the target base stations respectively; and

transmitting the network data to the current vehicle.

The embodiments of the device described above are only exemplary, where the units as separate components may or may not be physically separate, and the components illustrated as units may or may not be physical units, that is, they can be co-located or can be distributed on a plurality of network elements. A part or all of the units can be selected as needed in reality for the purpose of the solution according to the embodiments of the disclosure. This can be understood and practiced by those ordinarily skilled in the art without any inventive effort.

Those skilled in the art can clearly appreciate from the foregoing description of the embodiments that the embodiments of the disclosure can be implemented in hardware or in software plus a necessary general hardware platform. Based upon such understanding, the technical solutions above essentially or their parts contributing to the prior art can be embodied in the form of a computer software product which can be stored in a computer readable storage medium, e.g., an ROM/RAM, a magnetic disk, an optical disk, etc., and which includes several instructions to cause a computer device (e.g., a personal computer, a server, a network device, etc.) to perform the method according to the respective embodiments of the disclosure.

Lastly it shall be noted that the embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A vehicle-based network data transmission method, the method comprising:
receiving, by a server, a request from a current vehicle for acquiring network data;
obtaining information of a virtualized base station group according to the request; and
transmitting, by the server, the network data to the current vehicle through the virtualized base station group.

2. The method according to claim 1, wherein obtaining the information of the virtualized base station group according to the request comprises:
determining whether a virtualized base station group exists or not according to the request; if so, directly obtaining the information of the virtualized base station group; and if not, establishing a virtualized base station group.

3. The method according to claim 1, wherein the request includes identity authentication information of the vehicle; and after obtaining the information of the virtualized base station group according to the request, the method further comprises:
transmitting, by the server, the identity authentication information of the vehicle to the virtualized base station group, so that the virtualized base station group performs verification for the identity authentication information of the vehicle; if the verification passes, performing the operation of the server transmitting the network data to the vehicle through the virtualized base station group; and
if the verification fails, returning verification fail information to the server through the virtualized base station group.

4. The method according to claim 2, wherein the request includes identity authentication information of the vehicle; and after obtaining the information of the virtualized base station group according to the request, the method further comprises:
transmitting, by the server, the identity authentication information of the vehicle to the virtualized base station group, so that the virtualized base station group performs verification for the identity authentication information of the vehicle; if the verification passes, performing the operation of the server transmitting the network data to the vehicle through the virtualized base station group; and
if the verification fails, returning verification fail information to the server through the virtualized base station group.

5. The method according to claim 3, wherein establishing the virtualized base station group comprises:
obtaining navigation route information of the vehicle according to the request;
determining one or more of target base stations by which the vehicle passes according to the navigation route information; and
organizing the one or more of target base stations to form the virtualized base station group.

6. The method according to claim 4, wherein establishing the virtualized base station group comprises:
obtaining navigation route information of the vehicle according to the request;
determining one or more of target base stations by which the vehicle passes according to the navigation route information; and
organizing the one or more of target base stations to form the virtualized base station group.

7. The method according to claim 3, wherein the server transmitting the network data to the current vehicle through the virtualized base station group comprises:
receiving, by the server, verification pass authentication information transmitted by the target base stations respectively; and
transmitting, by the target base stations, the network data to the current vehicle.

8. The method according to claim 4, wherein the server transmitting the network data to the current vehicle through the virtualized base station group comprises:
receiving, by the server, verification pass authentication information transmitted by the target base stations respectively; and
transmitting, by the target base stations, the network data to the current vehicle.

9. The method according to claim 5, wherein the server transmitting the network data to the current vehicle through the virtualized base station group comprises:
receiving, by the server, verification pass authentication information transmitted by the target base stations respectively; and
transmitting, by the target base stations, the network data to the current vehicle.

10. The method according to claim 6, wherein the server transmitting the network data to the current vehicle through the virtualized base station group comprises:
receiving, by the server, verification pass authentication information transmitted by the target base stations respectively; and
transmitting, by the target base stations, the network data to the current vehicle.

11. A vehicle-based network data transmission device, the device comprising:
one or more processor; and
a memory; wherein
one or more computer readable program codes are stored in the memory, and the one or more processors are configured to execute the one or more computer readable program codes to perform:
receiving a request from a current vehicle for acquiring network data;
obtaining information of a virtualized base station group according to the request; and
transmitting the network data to the current vehicle through the virtualized base station group.

12. The device according to claim 11, wherein the obtaining the information of the virtualized base station group according to the request comprises:
determining whether a virtualized base station group exists or not according to the request; if so, directly obtaining the information of the virtualized base station group; and if not, establishing a virtualized base station group.

13. The device according to claim 11, wherein the request includes identity authentication information of the vehicle; and after obtaining the information of the virtualized base station group according to the request, the one or more computer readable program codes are further executed to perform:
transmitting the identity authentication information of the vehicle to the virtualized base station group, so that the virtualized base station group performs verification for the identity authentication information of the vehicle; if the verification passes, performing the operation of transmitting the network data to the vehicle through the virtualized base station group; and
if the verification fails, returning verification fail information to the server through the virtualized base station group.

14. The device according to claim 12, wherein the request includes identity authentication information of the vehicle; and after obtaining the information of the virtualized base station group according to the request, the one or more computer readable program codes are further executed to perform:
transmitting the identity authentication information of the vehicle to the virtualized base station group, so that the virtualized base station group performs verification for the identity authentication information of the vehicle; if the verification passes, performing the operation of transmitting the network data to the vehicle through the virtualized base station group; and
if the verification fails, returning verification fail information to the server through the virtualized base station group.

15. The device according to claim 13, wherein the establishing the virtualized base station group comprises:
obtaining navigation route information of the vehicle according to the request;
determining one or more of target base stations by which the vehicle passes according to the navigation route information; and
organizing the one or more of target base stations to form the virtualized base station group.

16. The device according to claim 14, wherein establishing the virtualized base station group comprises:
obtaining navigation route information of the vehicle according to the request;
determining one or more of target base stations by which the vehicle passes according to the navigation route information; and
organizing the one or more of target base stations to form the virtualized base station group.

17. The device according to claim 13, wherein the transmitting the network data to the current vehicle through the virtualized base station group comprises:
receiving verification pass authentication information transmitted by the target base stations respectively; and
transmitting the network data to the current vehicle.

18. The device according to claim 14, wherein the transmitting the network data to the current vehicle through the virtualized base station group comprises:
receiving verification pass authentication information transmitted by the target base stations respectively; and
transmitting the network data to the current vehicle.

19. The device according to claim 15, wherein the transmitting the network data to the current vehicle through the virtualized base station group comprises:
receiving verification pass authentication information transmitted by the target base stations respectively; and
transmitting the network data to the current vehicle.

20. The device according to claim 16, wherein the transmitting the network data to the current vehicle through the virtualized base station group comprises:
receiving verification pass authentication information transmitted by the target base stations respectively; and
transmitting the network data to the current vehicle.
